(19) United States
(12) Patent Application Publication
(10) Pub. No.: US 2006/0217488 A1
(43) Pub. Date: Sep. 28, 2006

(54) High impact prosthetic plastics

(75) Inventors: Karl-Heinz Renz, Jettingen (DE); Frank Uwe Stange, Langenargen (DE); Oliver Koschalka, Neuberg (DE); Albert Erdrich, Bad Nauheim (DE); Andreas Grundler, Wuppertal (DE)

Correspondence Address: Norris, McLaughlin & Marcus P.A., 18th Floor, 875 Third Avenue, New York, NY, 10022, US

(73) Assignee: Heraeus Kulzer GmbH, Hanau (DE)

(21) Appl. No.: 11/384,162

(22) Filed: Mar. 17, 2006

(30) Foreign Application Priority Data
Mar. 17, 2005 (DE) 10 2005 012 825.4

(51) Int. Cl. C08L 51/00

(52) U.S. Cl. 525/70

(57) ABSTRACT

An autopolymerizing two-component prosthetic base material consisting of A) a liquid monomer component, B) a powdered filler-containing component containing at least one bead polymer modified by an elastic phase,
which yields after curing a high-impact prosthetic plastic having a fracture toughness of ≧2 MPa·m^{1/2} and a fracture work of ≧900 J/m².

### BACKGROUND OF THE INVENTION

To produce technical dental prostheses (complete prostheses, partial prostheses, dental bridges, etc.) to be worn in the mouth, various materials are available:
1. Hot polymerizing plastics (one or two components). These plastics have a very high thermally induced volume shrinkage which results in an improper fit.
2. Autopolymerizing plastics (two components).
3. Photo-polymerizing plastics (one or two components).
4. Thermoplastics (one component); such materials are relatively difficult to process for dental applications.
5. Microwave curing plastics (one or two components). Here again, a very high thermally induced volume shrinkage results in an improper fit.

Furthermore, the prostheses made of the material listed under points 1 through 5 above can break easily if they are dropped or otherwise handled carelessly. These unwanted properties are eliminated by the use of so-called high-impact plastics (The term high-impact is explained in greater detail in ISO 1567—Denture Base Materials. According to this standard, the prosthetic plastic is a high-impact denture base material if it exceeds a value of 2 kJ/m² in terms of impact strength according to ISO 1567 (based on Charpy)):
6. Hot polymerizing high-impact plastics (one or two components). However, these have an undesirably high thermally induced volume shrinkage that results in an improper fit.

On the market, however, the differentiation between high impact material and other plastics is not regulated uniformly because the measurement method is inadequate. To determine the high impact property, a new test method (fracture toughness) is therefore to be used. The fracture toughness measurement is based on ASTM E 399-90 and has been modified for prosthetic plastics. It has been decided that this method will be introduced into ISO 1567 as a replacement for the Charpy impact toughness, which is to be done in the near future.

DE 199 41 829 describes autopolymerizable dental compositions containing bead polymers and yielding prosthetic base materials, for example.

DE 196 17 876 A1 describes dental materials with polysiloxane impact strength modifiers. After being cured, they have an improved impact strength.

U.S. Pat. No. 5,182,332 describes dental compositions having grafted copolymer that contain rubber.

Attempts to develop an autopolymerizing prosthetic plastic that will have the properties of a high-impact prosthetic plastic while avoiding the disadvantage of the high thermally induced volume shrinkage have now been successful. This plastic surprisingly conforms to the future ISO Standard 1567.

The starting blends for prosthetic plastics usually consist of a monomer component and a powder component that are mixed together prior to use.

The high-impact property is achieved by using a bead polymer modified by an elastic phase in the powder component instead of using a traditional bead polymer.

### SUMMARY OF THE INVENTION

The present invention thus relates to prosthetic plastic compositions containing at least one bead polymer modified by an elastic phase. In particular the present invention relates to an autopolymerizable two-component prosthetic base material consisting of
A) a liquid monomer component
B) a powdered filler-containing component that contains at least one bead polymer modified by an elastic phase,
   which yields after curing a high-impact prosthetic plastic having a fracture toughness of ≧2 MPa-m^{1/2} and a fracture work of ≧900 J/m².

Components A) and/or B) preferably contain substances from the groups of fillers, pigments, stabilizers and regulators in addition.

The invention also relates to the cured plastic which is in compliance with the future ISO Standard 1567, namely a high-impact prosthetic plastic having a fracture toughness of ≧2 MPa-m^{1/2} and a fracture work of ≧900 J/m², containing at least one bead polymer modified by an elastic phase.

### DETAILED DESCRIPTION

The bead polymer may be modified by the following elastic materials, e.g.:
1. Butadiene-styrene copolymer (ref.: J. Dent., 1986; 14; 214-217 and/or U.S. Pat. No. 3,427,274)
2. Poly(n-butyl acrylate) (PBA) (ref.: Polymer, Volume 39, Number 14, 1998, 3073-3081)
3. Silicone rubber graft copolymers (ref.: Geck et al. in Auner & Weis (eds.), Organosilicon Chemistry II, Munich Silicone Convention, 1994, 673-684, VCH Weinheim, Germany, WO 03/066728 A2)

The distribution of the elastic phase in the solid matrix may appear as follows:
a) elastic core in a solid shell (core-shell particles);
b) multiple elastic cores in a solid matrix;
c) core-shell particles from a) distributed in a solid matrix;
d) elastic and solid phases together form interpenetrating networks. Regarding a), b) and c): The elastic phase has a diameter between 10 nm and 100 μm, preferably between 60 and 5000 nm.

The monomers may be selected from the monomers conventionally used in the dental field. Examples include free radically polymerizable monofunctional monomers such as mono (meth)acrylates, methyl, ethyl, butyl, benzyl, furfuryl or phenyl (meth)acrylates, di- or polyfunctional monomers such as di- or polyfunctional acrylates or methacrylates, bisphenol A-di(meth)acrylate, bis-GMA (an addition product of methacrylic acid and bisphenol A diglycidyl ether), UDMA (an addition product of 2-hydroxyethyl methacrylate and 2,2,4-hexamethylene diisocyanate), di-, tri- or tetraethylene glycol di(meth)acrylate, decanediol di(meth)acrylate, dodecanediol (meth)acrylate, hexyldecanediol di(meth)acrylate, trimethylolpropane tri(meth)acrylate, pentaerythritol tetra (meth) acrylate and butanediol di(meth)acrylate, ethylene glycol di(meth)acrylate, polyethylene glycol di(meth)acrylates, ethoxylated/propoxylated bisphenol A di(meth)acrylates.

Examples of suitable fillers include pyrogenic or precipitated silicas, dental glasses such as aluminosilicate glass or fluoroaluminosilicate glass, strontium silicate, strontium borosilicate, lithium silicate, lithium aluminum silicate, layer silicates, zeolites, amorphous spherical fillers based on oxide or mixed oxide (SiO₂, ZrO₂ and/or TiO₂), metal oxides with a primary particle size of approx. 40 to 300 nm, splinter polymers with 10 to 100 μm particle size (see R. Janda, Kunststofverbundsysteme [Plastic Laminate Systems], VCH Verlagsgesellschaft, Weinheim, 1990, pp. 225 ff.) or mixtures thereof. Furthermore, reinforcing agents such as glass fibers, nylon or carbon fibers may also be incorporated.

The fillers are usually used in amounts of 0 to 80 wt %, preferably 0 to 3 wt %, based on the total prosthetic plastic composition and/or the sum of components A and B.

Examples of suitable regulators for adjusting the molecular weight include:

TGEH: thioglycolic acid 2-ethylhexyl ester

t-DDM: tert-dodecylmercaptan

GDMA: glycol dimercaptoacetate

Initiators:

LPO: dilauroyl peroxide

BPO: dibenzoyl peroxide

t-BPEH: tert-butyl per-2-ethylhexanoate

ADMV: 2,2′-azobis(2,4-dimethyl valeronitrile)

AIBN: 2,2′-azobis-(isobutyronitrile)

DTBP: di-tert-butyl peroxide

Suitable stabilizers include, for example, hydroquinone monomethyl ether or 2,6-ditert-butyl4-methylphenol (BHT).

In addition, the inventive prosthetic basic materials may also contain other conventional additives, e.g., from the group of antimicrobial additives, UV absorbers, thixotroping agents, catalysts and crosslinking agents.

Such additives—such as pigments, stabilizers and regulators—should be used in small amounts, e.g., a total of 0.01 to 3.0 wt %, especially 0.01 to 1.0 wt %, based on the total weight of the material.

The compositions are preferably cured by redox-induced free radical polymerization at room temperature and/or at a slightly elevated temperature under slight pressure to prevent bubbling.

Examples of suitable initiators for polymerization performed at room temperature include redox initiator combinations, e.g., combinations of benzoyl peroxide or lauryl peroxide with N,N-dimethyl-sym-xylidine or N,N-dimethyl-p-toluidine. An especially preferred initiator system consists of a combination of barbituric acids in conjunction with copper and chloride ions and the above-mentioned peroxides. This system is characterized by a high color stability.

The materials of the present invention are preferably used in the dental field, especially for the manufacture of prostheses or dental orthopedic apparatuses for correcting the position of teeth. However, other possible applications can be found in all areas where a high-impact molded article is to be created on an individualized basis, e.g.,
bone cements having an improved impact strength
applications in veterinary medicine where the impact strength must be high, e.g., hoof repair material or dental prostheses for animals.

### EXAMPLE

The following example is presented to illustrate the present invention:

Inventive composition:

A monomer mixture consisting of

93.85% methyl methacrylate, 6% butanediol dimethacrylate, 0.15% trioctylmethyl ammonium chloride, 10 ppm copper(II) chloride dihydrate

and a powder component consisting of

30% polymethyl methacrylate (e.g., Plexidon M449 from the company Roehm GmbH), 67.8% of a bead polymer modified by an elastic phase (e.g., DA 441 from MV Plastics Ltd.), 0.9% 1-benzyl-5-phenylbarbituric acid, 0.3% 5-n-butylbarbituric acid, 1% dibenzoyl peroxide

is prepared to form a paste, then the mixture is placed in a casting mold and polymerized at 55° C. for 30 minutes.

Comparative composition:

A monomer mixture consisting of

93.85% methyl methacrylate, 6% butanediol dimethacrylate, 0.15% trioctylmethyl ammonium chloride, 10 ppm copper(II) chloride dihydrate

and a powder component consisting of

20% polymethyl methacrylate (e.g., Plexidon M449 from Roehm GmbH), 78.8% polymethyl methacrylate copolymer, 0.9% 1-benzyl-5-phenylbarbituric acid, 0.3% 5 n-butylbarbituric acid, 0.8% dibenzoyl peroxide

are prepared to a paste, placed in a casting mold and polymerized for 30 minutes at 55° C.

Sample bodies are cut from the cured plastic and measurement are performed on them according to ASTM E 399-90, modified for prosthetic plastics.

The following mechanical test values are obtained:

| | Comparison | | Inventive | |
|---|---|---|---|---|
| | traditional bead polymer | | modified bead polymer | |
| Fracture toughness | 1.4 | MPa · m^{1/2} | 2.1 | MPa · m^{1/2} |
| Fracture work | 183 | J/m² | 1026 | J/m² |

Experimental result:

The values of the inventive composition are definitely higher than those of the traditional autopolymer used in the past. Consequently the material has greater mechanical stability and will even fulfill the new minimum requirements of the ISO for high-impact plastics (2 MPa·m^{1/2} and 900 J/m²).

We claim:

1. Autopolymerizable two-component prosthetic basic material comprised of
A) a liquid monomer component,
B) a powdered filler-containing component which comprises at least one bead polymer modified by an elastic phase, yielding after curing a high-impact prosthetic plastic having a fracture toughness of ≧2 MPa·m^{1/2} and a fracture work of ≧900 J/m².

2. Two component prosthetic basic material according to claim 1, wherein the elastic phase is selected from the group consisting of
a. Poly-(n-butyl acrylate) (PBA)
b. Butadiene-styrene copolymer, and
c. Silicone rubber (graft copolymers).

3. Two-component prosthetic basic material according to claim 1 further comprising one or more substances from the groups consisting of fillers, pigments, stabilizers, regulators, antimicrobial additives, UV absorbers, thixotroping agents, catalysts and crosslinking agents

4. A high-impact prosthetic plastic having a fracture toughness of ≧2 MPa·m^{1/2} and a fracture work of ≧900 J/m² formed from the basic material of claim 1.
